(19) United States
(12) Patent Application Publication
(10) Pub. No.: US 2023/0395813 A1
(43) Pub. Date: Dec. 7, 2023

(54) FUEL ELECTRODE AND ELECTROCHEMICAL CELL

(71) Applicant: DENSO CORPORATION, Kariya-city (JP)

(72) Inventor: Shingo SAKAI, Kariya-city (JP)

(21) Appl. No.: 18/453,301

(22) Filed: Aug. 21, 2023

Related U.S. Application Data
(63) Continuation of application No. PCT/JP2021/044663, filed on Dec. 6, 2021.

(30) Foreign Application Priority Data
Feb. 26, 2021 (JP) 2021-030030

(51) Int. Cl. H01M 4/86; H01M 4/90; H01M 8/1246; C25B 13/05; C25B 11/031; C25B 11/091

(52) U.S. Cl. CPC H01M 4/8621; H01M 4/905; H01M 4/8673; H01M 2008/1293; C25B 13/05; C25B 11/031; C25B 11/091; H01M 8/1246

(57) ABSTRACT

A fuel electrode is an electrode which is adopted to an electrochemical cell including a solid electrolyte layer having oxide ion conductivity, and to which a fuel is supplied. The fuel electrode includes ion conductive particles having oxide ion conductivity, metal particles, oxygen storage particles having oxygen storage capacity, and pores. The electrochemical cell includes the solid electrolyte layer having oxide ion conductivity, the fuel electrode disposed on one surface of the solid electrolyte layer, and an electrode disposed on another surface of the solid electrolyte layer and paired with the fuel electrode.

### CROSS REFERENCE TO RELATED APPLICATIONS

The present application is a continuation application of International Patent Application No. PCT/JP2021/044663 filed on Dec. 6, 2021, which designated the U.S. and claims the benefit of priority from Japanese Patent Application No. 2021-030030 filed on Feb. 26, 2021. The entire disclosures of all of the above applications are incorporated herein by reference.

### TECHNICAL FIELD

The present disclosure relates to a fuel electrode and an electrochemical cell.

### BACKGROUND

Conventionally, there has been known electrochemical cells such as a solid oxide fuel cell (hereinafter also referred to as SOFC) and a solid oxide electrolysis cell (hereinafter also referred to as SOEC) each including a solid electrolyte layer having oxygen ion conductivity. In general, a fuel electrode of an SOFC is supplied with hydrogen gas as fuel, and a power generation reaction of H₂+O₂⁻→H₂O+2e⁻ occurs. A fuel electrode of an SOEC is supplied with water vapor gas as fuel, and a water electrolysis reaction of H₂O+2e⁻→H₂+O₂^{- occurs.}

### SUMMARY

A fuel electrode according to an aspect of the present disclosure is configured to be adopted to an electrochemical cell that includes a solid electrolyte layer having oxide ion conductivity, and to be supplied with a fuel. The fuel electrode includes ion conductive particles having oxide ion conductivity, metal particles, oxygen storage particles having oxygen storage capacity, and pores.

An electrochemical cell according to another aspect of the present disclosure includes a solid electrolyte layer having oxide ion conductivity, the fuel electrode disposed on one surface of the solid electrolyte layer, and an electrode disposed on another surface of the solid electrolyte layer and paired with the fuel electrode.

### BRIEF DESCRIPTION OF DRAWINGS

Objects, features and advantages of the present disclosure will become apparent from the following detailed description made with reference to the accompanying drawings. In the drawings:

FIG. 1 is an explanatory diagram illustrating an example of a cross section of a fuel electrode and an electrochemical cell according to a first embodiment;

FIG. 2A is a diagram illustrating a microstructure and an effect of a fuel electrode of a comparative example in a case of being adopted in an SOFC;

FIG. 2B is a diagram illustrating a microstructure and an effect of the fuel electrode of the first embodiment in a case of being adopted in an SOFC;

FIG. 3A is a diagram illustrating a microstructure and an effect of the fuel electrode of the comparative example in a case of being adopted in an SOEC;

FIG. 3B is a diagram illustrating a microstructure and an effect of the fuel electrode of the first embodiment in a case of being adopted in an SOEC;

FIG. 4A is a diagram illustrating a cross section of an electrochemical cell along a thickness direction of a fuel electrode according to a second embodiment;

FIG. 4B is a diagram illustrating an example of a concentration distribution of oxygen storage particles viewed in the cross section along the thickness direction of the fuel electrode according to the second embodiment;

FIG. 4C is a diagram illustrating another example of the concentration distribution of oxygen storage particles viewed in the cross section along the thickness direction of the fuel electrode according to the second embodiment;

FIG. 4D is a diagram illustrating another example of the concentration distribution of oxygen storage particles viewed in the cross section along the thickness direction of the fuel electrode according to the second embodiment;

FIG. 5A is diagram illustrating a surface of an fuel electrode located opposite an solid electrolyte layer and a flow of a fuel in an electrochemical cell according to a third embodiment;

FIG. 5B is a diagram illustrating an example of a concentration distribution of oxygen storage particles viewed on the surface of the fuel electrode located opposite the solid electrolyte layer;

FIG. 5C is a diagram illustrating another example of the concentration distribution of oxygen storage particles viewed on the surface of the fuel electrode located opposite the solid electrolyte layer;

FIG. 5D is a diagram illustrating another example of the concentration distribution of oxygen storage particles viewed on the surface of the fuel electrode located opposite the solid electrolyte layer;

FIG. 6A is diagram illustrating a surface of an fuel electrode located opposite an solid electrolyte layer and a flow of a fuel in an electrochemical cell according to a fourth embodiment;

FIG. 6B is a diagram illustrating an example of a concentration distribution of oxygen storage particles viewed on the surface of the fuel electrode located opposite the solid electrolyte layer;

FIG. 6C is a diagram illustrating another example of the concentration distribution of oxygen storage particles viewed on the surface of the fuel electrode located opposite the solid electrolyte layer;

FIG. 6D is a diagram illustrating another example of the concentration distribution of oxygen storage particles viewed on the surface of the fuel electrode located opposite the solid electrolyte layer;

FIG. 7 is a diagram showing a distribution of La elements by TEM-EDX in a cross section of a fuel electrode in Sample 1 obtained in Experimental Example 1;

FIG. 8 is a diagram showing a distribution of Ce elements by TEM-EDX in a cross section of a fuel electrode in Sample 1C obtained in Experimental Example 1;

FIG. 9 is a diagram showing durability test results of the electrochemical cells of Sample 1, Sample 1C, and Sample 2C obtained in Experimental Example 1;

FIG. 10 is a diagram showing measurement results of oxygen storage capacities of various oxygen storage materials obtained in Experimental Example 2;

FIG. 11 is a diagram showing X-ray diffraction patterns of single fired products and mixed fired products of YSZ, NiO, and LCZ obtained in Experimental Example 3; and

FIG. 12 is a diagram showing X-ray diffraction patterns of single fired products and mixed fired products of YSZ, NiO, and CZ obtained in Experimental Example 3.

### DETAILED DESCRIPTION

Next, a relevant technology is described only for understanding the following embodiments. A solid oxide fuel cell may adopt a fuel electrode having an electrode skeleton composed of an ion conductive oxide and a Ni-based metal alloy. In the solid oxide fuel cell, destruction of an electrode due to oxidation and reduction of a metal constituting the electrode can be restricted and excellent electrode performance can be obtained.

In short, the solid oxide fuel cell may use a Ni alloy instead of metal Ni conventionally used for a fuel electrode. However, this technique has an issue that an electrode activity of the fuel electrode is lowered because Ni is alloyed. On the other hand, when a non-alloyed metal such as metal Ni is used as it is, water vapor oxidation of the metal occurs due to water vapor gas generated by the power generation reaction or water vapor gas supplied for the water electrolysis reaction, and the fuel electrode deteriorates.

A fuel electrode according to an aspect of the present disclosure is configured to be adopted to an electrochemical cell that includes a solid electrolyte layer having oxide ion conductivity, and to be supplied with a fuel. The fuel electrode includes ion conductive particles having oxide ion conductivity, metal particles, oxygen storage particles having oxygen storage capacity, and pores.

An electrochemical cell according to another aspect of the present disclosure includes a solid electrolyte layer having oxide ion conductivity, the fuel electrode disposed on one surface of the solid electrolyte layer, and an electrode disposed on another surface of the solid electrolyte layer and paired with the fuel electrode.

The above-described fuel electrode has the above configuration. Therefore, when the above-described fuel electrode is adopted as a fuel electrode of an SOFC or an SOEC, deterioration of the fuel electrode due to water vapor gas can be restricted while restricting decrease in electrode activity.

In addition, the above-described electrochemical cell includes the above-described fuel electrode. Therefore, when the electrochemical cell is adopted as an SOFC or an SOEC, deterioration of the fuel electrode due to water vapor gas can be restricted while restricting decrease in electrode activity of the fuel electrode, and thus the electrochemical cell is excellent in long-term stability.

Reference numerals in parentheses described in claims indicate a correspondence relationship with specific means described in embodiments described later, and do not limit a technical scope of the present disclosure.

### First Embodiment

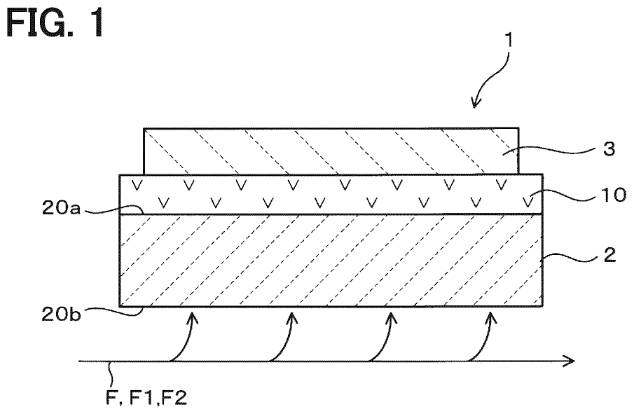

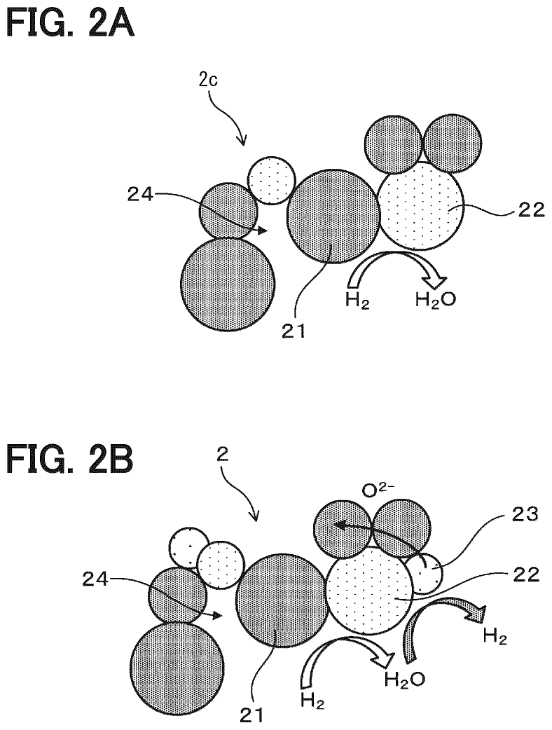

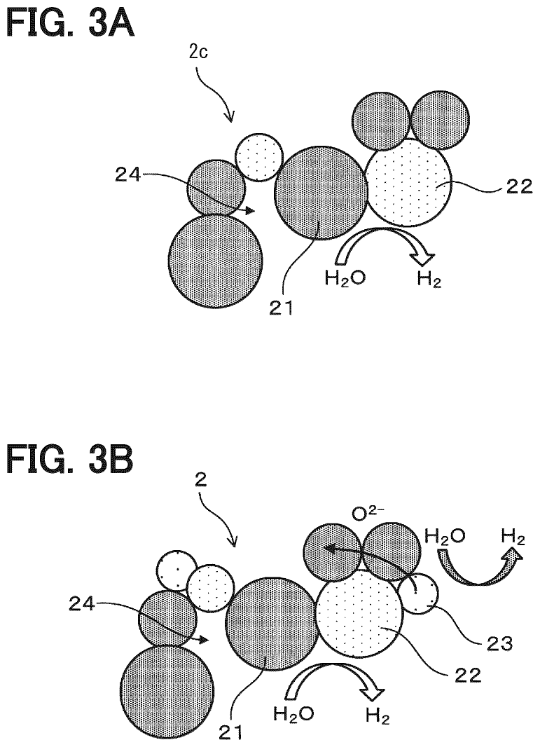

A fuel electrode and an electrochemical cell according to a first embodiment will be described with reference to FIGS. 1 to 3B. As illustrated in FIG. 1, a fuel electrode 2 according to the present embodiment is adopted to an electrochemical cell 1 according to the present embodiment. The electrochemical cell 1 includes a solid electrolyte layer 10 having oxide ion conductivity. Specifically, the electrochemical cell 1 is adopted to at least one of a solid oxide fuel cell (SOFC) including a solid electrolyte layer 10 having oxide ion conductivity and a solid oxide electrolysis cell (SOEC) including a solid electrolyte layer 10 having oxide ion conductivity. As illustrated in FIG. 2B and FIG. 3B, the fuel electrode 2 includes ion conductive particles 21 having oxide ion conductivity, metal particles 22, oxygen storage particles 23 having oxygen storage capacity, and pores 24. It is known that both a power generation reaction of the SOFC and a water electrolysis reaction of the SOEC proceed at a three-phase interface where all of the ion conductive particle 21, the metal particle 22, and the pore 24 are in contact with each other.

When the fuel electrode 2 of the present embodiment is adopted as the fuel electrode 2 of the SOFC or the SOEC, deterioration of the fuel electrode 2 due to water vapor gas can be restricted while restricting decrease in electrode activity. An estimation mechanism by which such an effect is obtained will be described with reference to FIGS. 2A to 3B.

As illustrated in FIG. 2A and FIG. 3A, a fuel electrode including the ion conductive particles 21, the metal particles 22, and the pores 24 and not including the oxygen storage particles 23 is defined as a fuel electrode 2c of a comparative example. In the fuel electrode 2c of the comparative example, at the time of the power generation of the SOFC shown in FIG. 2A, the metal particles 22 are water vapor oxidized by high-temperature H₂O (water vapor gas) generated by a power generation reaction of H₂+O₂⁻→H₂O+2e⁻. In addition, in the fuel electrode 2c of the comparative example, at the time of the water electrolysis of the SOEC shown in FIG. 3A, a water electrolysis reaction of H₂O+2e⁻→H₂+O₂⁻ occurs. Therefore, in the fuel electrode 2c of the comparative example, the metal particles 22 are water vapor oxidized by high-temperature H₂O (water vapor gas) supplied as fuel. As described above, in the fuel electrode 2c of the comparative example, the metal particles 22 become metal oxide particles due to the water vapor oxidation of the metal particles 22, and the electrode activity decreases.

On the other hand, in the fuel electrode 2 of the present embodiment, at the time of power generation of the SOFC shown in FIG. 2B, high-temperature H₂O (water vapor gas) is generated by the power generation reaction of H₂+O₂⁻→H₂O+2e⁻. Instead of the water vapor oxidation of the metal particles 22 by the water vapor gas, the oxide ions O₂⁻ are temporarily occluded in the oxygen storage particles 23 and are released to the ion conductive particles 21. Therefore, when the fuel electrode 2 of the present embodiment is adopted as the fuel electrode 2 of the SOFC, oxidation of the metal particles 22 by the high-temperature water vapor gas generated by the power generation reaction is restricted, and deterioration of the fuel electrode 2 can be restricted. In addition, in the fuel electrode 2 of the present embodiment, since it is not necessary to alloy a metal constituting the metal particles 22, and a metal having catalytic activity can be used as it is, it is possible to restrict decrease in electrode activity.

In addition, in the fuel electrode 2 of the present embodiment, at the time of the water electrolysis of the SOEC shown in FIG. 3B, the oxide ions O₂⁻ generated by the water electrolysis reaction of H₂O+2e⁻→H₂+O₂⁻ are temporarily occluded in the oxygen storage particles 23 without being consumed by the oxidation of the metal particles 22, and are released to the ion conductive particles 21. Therefore, when the fuel electrode 2 of the present embodiment is adopted as the fuel electrode 2 of the SOEC, oxidation of the metal particles 22 by the water vapor gas supplied as fuel for water electrolysis is restricted, and deterioration of the fuel electrode 2 can be restricted. In addition, in the fuel electrode 2 of the present embodiment, since it is not necessary to alloy the metal constituting the metal particles 22, and the metal having catalytic activity can be used as it is, it is possible to restrict decrease in electrode activity.

The electrochemical cell 1 of the present embodiment includes the fuel electrode 2 of the present embodiment. Therefore, when the electrochemical cell 1 of the present embodiment is adopted as the SOFC or the SOEC, deterioration of the fuel electrode 2 due to water vapor gas can be restricted while restricting decrease in electrode activity of the fuel electrode 2, and thus the electrochemical cell 1 is excellent in long-term stability. Note that, in the electrochemical cell 1 of the present embodiment, a part of the metal constituting the metal particles 22 is not prevented from being inevitably alloyed at the time of manufacturing the fuel electrode 2 or the like.

Hereinafter, the fuel electrode 2 of the present embodiment and the electrochemical cell 1 of the present embodiment will be described in more detail.

### Fuel Electrode

The fuel electrode 2 is an electrode to which the fuel F is supplied. Specifically, when the electrochemical cell 1 is operated as the SOFC, a hydrogen-containing gas F1 such as hydrogen gas is supplied to the fuel electrode 2 as the fuel F. On the other hand, when the electrochemical cell 1 is operated as the SOEC, a water (H₂O)-containing gas F2 such as a water vapor gas is supplied to the fuel electrode 2 as the fuel F. The hydrogen-containing gas F1 may contain water vapor for humidification or the like. The water-containing gas F2 may include a reducing gas such as hydrogen gas. The fuel electrode 2 is usually formed to be porous so that a gaseous fuel can spread.

As described above, the fuel electrode 2 includes the ion conductive particles 21, the metal particles 22, the oxygen storage particles 23, and the pores 24.

The ion conductive particles 21 have oxide ion conductivity. Examples of an oxide ion conductive material constituting the ion conductive particles 21 include zirconium oxide-based oxides such as yttria-stabilized zirconia and scandia-stabilized zirconia. The ion conductive particles 21 may include one or more kinds of oxide ion conductive material.

As a metal material constituting the metal particles 22, various metals having catalytic activity can be used. Examples of such a metal include Ni (nickel), Cu (copper), and Co (cobalt). The metal particles 22 may include one or more kinds of metal. Specifically, at least one selected from the group consisting of Ni particles, Cu particles, and Co particles can be suitably used as the metal particles 22 from the viewpoint of high electrical conductivity, high catalytic activity, and the like.

The oxygen storage particles 23 have an oxygen storage capacity (OSC). As an oxygen storage material constituting the oxygen storage particles 23, an oxide containing Zr (zirconium) and at least one element selected from the group consisting of Al (aluminum), Ce (cerium), La (lanthanum), Pr (praseodymium), Nd (neodymium), Y (yttrium), and Sc (scandium) can be suitably used. According to this configuration, it is easy to increase the oxygen storage capacity of the oxygen storage particles 23, and it is possible to more reliably restrict the water vapor oxidation of the metal particles 22 having catalytic activity. Specific examples of the oxygen storage material include an oxide containing Zr and at least one element selected from the group consisting of Al, Ce, La, Pr, Nd, Y, and Sc, and an oxide containing Ce and Zr and at least one element selected from the group consisting of Al, La, Pr, Nd, Y, and Sc. More specifically, examples of the oxygen storage material include an Al—Ce—Zr oxide containing Al, Ce, and Zr, an Y—Ce—Zr oxide containing Y, Ce, and Zr (hereinafter, also simply referred to as YCZ), a Sc—Ce—Zr oxide containing Sc, Ce, and Zr (hereinafter, also simply referred to as SCZ), and a La—Ce—Zr oxide containing La, Ce, and Zr (hereinafter, also simply referred to as LCZ). The oxygen storage particles 23 may include one or more kinds of the oxygen storage material.

The oxygen storage particles 23 can be synthesized, for example, as follows. An Al source, a Ce source, a La source, a Pr source, a Nd source, an Y source, a Sc source, a Zr source, and the like, which are starting materials of the oxygen storage material constituting the oxygen storage particles 23, are weighed so as to have a predetermined mol ratio. Each starting material can be provided in the form of nitrate or the like. Next, the starting material is dissolved in an aqueous solution, a target material precursor is precipitated with a base such as ammonia water or sodium hydroxide aqueous solution (coprecipitation method), and then the target material precursor is recovered by filtration. Next, the obtained precursor powder is dried, placed in an alumina crucible or the like, and fired at, for example, 300° C. to 1500° C. in an air atmosphere, a reducing atmosphere such as H₂, or an inert atmosphere such as nitrogen and argon. Accordingly, the oxygen storage particles 23 described above can be obtained.

The oxygen storage capacity of the oxygen storage particles 23 can be measured by thermogravimetric analysis (TGA) of the oxygen storage material constituting the oxygen storage particles 23. When the amount of weight loss by thermogravimetric analysis per 15 mg of the oxygen storage material constituting the oxygen storage particles 23 is 0.02 mg or more, the oxygen storage particles 23 are considered to have oxygen storage capacity. The thermogravimetric analysis is performed under the following conditions: measurement sample powder weight, 15 mg; measurement temperature, 700° C.; measurement gas, hydrogen-containing gas consisting of 5 volume % hydrogen and 95 volume % nitrogen and oxygen-containing gas consisting of 5 volume % oxygen and 95 volume % nitrogen are switched every 5 minutes; and gas flow rate, 100 m L/min.

The amount of weight reduction by thermogravimetric analysis per 15 mg of the oxygen storage material constituting the oxygen storage particles 23 can be set to preferably 0.03 mg or more, more preferably 0.035 mg or more, and even more preferably 0.04 mg or more from the viewpoint of enhancing the effect of restricting water vapor oxidation of the metal particles 22. The amount of weight reduction is preferably large from the viewpoint of enhancing the effect of restricting water vapor oxidation of the metal particles 22. Therefore, the upper limit of the amount of weight loss is not particularly limited, but the amount of weight loss can be, for example, 2.00 mg or less from the viewpoint of inhibition of oxide ion conduction or the like.

It is important that the above-described oxygen storage material is present as particles (can be disposed as particles) in the fuel electrode 2. This is because it is difficult to restrict water vapor oxidation of the metal particles 22 in a state in which the oxygen storage material is not present as particles and elements such as Ce constituting the oxygen storage material are substantially dissolved in the metal particles 22 and the ion conductive particles 21. Note that it is difficult for a Ce—Zr oxide including Ce, Zr, and O (oxygen) to maintain a crystal structure after firing of the fuel electrode 2, and to be present in the form of particles in the fuel electrode 2. In addition, the fuel electrode 2 may have a configuration that does not have a concentration distribution of the oxygen storage particles 23, that is, a configuration in which the concentration of the oxygen storage particles 23 can be considered to be constant. The fuel electrode 2 may have a concentration distribution of the oxygen storage particles 23. The latter example will be described later in the second embodiment to the fourth embodiment.

The fuel electrode 2 preferably has a microstructure in which the oxygen storage particles 23 are in contact with the ion conductive particles 21, the metal particles 22, and the pores 24. According to this configuration, since the oxygen storage particles 23 are present at positions where the water vapor gas is in contact with the metal particles 22, the effect of restricting the water vapor oxidation of the metal particles 22 is easily exerted. It is not required that all of the oxygen storage particles 23 contained in the fuel electrode 2 are in contact with all of the ion conductive particles 21, the metal particles 22, and the pores 24 as long as the fuel electrode 2 can exhibit the above-described effects.

The oxygen storage particles 23 preferably have a crystal structure of a pyrochlore structure or a fluorite structure. According to this configuration, it is easy to exhibit high oxygen storage capacity, and it is possible to more reliably restrict water vapor oxidation of the metal particles 22.

The ratio of the ion conductive particles 21 to the metal particles 22 contained in the fuel electrode 2 can be set to preferably 10:90 to 90:10, more preferably 20:80 to 80:20, and even more preferably 30:70 to 70:30 in terms of the mass ratio from the viewpoint of the formability of an oxide ion conductive path and an electron conductive path, a balance between the oxide ion conductivity and the electron conductivity, and the like. In addition, the content of the oxygen storage particles 23 contained in the fuel electrode 2 can be set to preferably 1 mass % or more, more preferably 2 mass % or more, even more preferably 3 mass % or more, even more preferably 4 mass % or more, and even more preferably 5 mass % or more with respect to the total mass of the ion conductive particles 21 and the metal particles 22 from the viewpoint of ensuring the above-described action and effect. The content of the oxygen storage particles 23 contained in the fuel electrode 2 can be set to preferably 30 mass % or less, more preferably 25 mass % or less, and even more preferably 20 mass % or less with respect to the total mass of the ion conductive particles 21 and the metal particles 22 from the viewpoint of restricting decrease in the electron conductivity and the oxide ion conductivity of the fuel electrode 2. The ratio between the ion conductive particles 21 and the metal particles 22 and the content of the oxygen storage particles 23 can be measured by inductively coupled plasma (ICP) emission spectrometry of a solution obtained by dissolving the fuel electrode 2 in a strong acid.

In the fuel electrode 2, the average particle diameter of the oxygen storage particles 23 may be preferably 100 nm or more, more preferably 300 nm or more, and even more preferably 500 nm or more from the viewpoint of ensuring the oxygen storage capacity. The average particle diameter of the oxygen storage particles 23 can be set to preferably 10 μm or less, more preferably 8 μm or less, and even more preferably 5 μm or less from the viewpoint of preventing the conduction of oxide ions from being hindered during the electrode reaction such as the power generation reaction or the water electrolysis reaction.

In the fuel electrode 2, the average particle diameter of the ion conductive particles 21 may be preferably 50 nm or more, more preferably 75 nm or more, and even more preferably 100 nm or more from the viewpoint of strength, oxide ion conductivity, and the like. The average particle diameter of the ion conductive particles 21 can be set to preferably 5 μm or less, more preferably 3 μm or less, and even more preferably 1 μm or less from the viewpoint of increasing the density of the three-phase interface in the fuel electrode 2 in order to ensure the electrode performance.

In the fuel electrode 2, the average particle diameter of the metal particles 22 may be preferably 50 nm or more, more preferably 75 nm or more, and even more preferably 100 nm or more from the viewpoint of electron conductivity and the like. The average particle diameter of the metal particles 22 may be preferably 5 μm or less, more preferably 3 μm or less, and even more preferably 1 μm or less from the viewpoint of increasing the density of the three-phase interface in the fuel electrode 2 in order to ensure the electrode performance.

The average particle diameter of the oxygen storage particles 23 is an arithmetic average value of particle diameters measured for any ten oxygen storage particles 23 specified in a cross section along the thickness direction of the fuel electrode 2 by TEM-EDX analysis (transmission electron microscope-energy dispersive X-ray analysis). Similarly, the average particle diameter of the ion conductive particles 21 is an arithmetic average value of particle diameters measured for any ten ion conductive particles 21 specified in the cross section. The average particle diameter of the metal particles 22 is an arithmetic average value of particle diameters measured for any ten metal particles 22 specified in the cross section.

The fuel electrode 2 may be formed in a layer shape, and may be composed of a single layer or multiple layers. FIG. 1 shows an example in which the fuel electrode 2 is composed of a single layer. When the fuel electrode 2 includes multiple layers, the fuel electrode 2 may specifically include, for example, a reaction layer (not illustrated in the first embodiment) disposed on the solid electrolyte layer 10 and a diffusion layer (not illustrated in the first embodiment) disposed opposite the solid electrolyte layer 10. The reaction layer is a layer in which an electrochemical reaction mainly occurs in the fuel electrode 2, and can also be referred to as an active layer. The diffusion layer is a layer capable of diffusing the supplied fuel in the in-plane direction of the fuel electrode 2.

When the fuel electrode 2 functions as a support (described in detail later), the thickness of the fuel electrode 2 may be, for example, preferably 100 to 800 μm, more preferably 150 to 700 μm, and even more preferably 200 to 600 μm from the viewpoint of strength, oxide ion conductivity, electron conductivity, gas diffusivity, and the like. When the fuel electrode 2 is not made to function as a support, the thickness of the fuel electrode 2 can be, for example, preferably 10 to 500 μm, more preferably 15 to 300 μm, and even more preferably 20 to 200 μm from the viewpoint of oxide ion conductivity, electron conductivity, gas diffusivity, and the like.

### Electrochemical Cell

The electrochemical cell 1 of the present embodiment can be configured to include the solid electrolyte layer 10 having oxide ion conductivity, the fuel electrode 2 of the present embodiment disposed on one surface of the solid electrolyte layer 10, and an electrode 3 disposed on another surface of the solid electrolyte layer 10 and paired with the fuel electrode 2. Specifically, FIG. 1 shows an example in which the fuel electrode 2, the solid electrolyte layer 10, and the electrode 3 are stacked in this order and joined to each other.

The electrochemical cell 1 may further include an intermediate layer (not illustrated) between the solid electrolyte layer 10 and the electrode 3. The intermediate layer is a layer mainly for restricting the reaction between the material of the solid electrolyte layer 10 and the material of the electrode 3. In this case, specifically, the electrochemical cell 1 may have a configuration in which the fuel electrode 2, the solid electrolyte layer 10, the intermediate layer, and the electrode 3 are stacked in this order and joined to each other. The electrochemical cell 1 may have a flat cell structure. In addition, the electrochemical cell 1 may be configured such that the fuel electrode 2 functions as both an electrode and a support, may be configured such that the solid electrolyte layer 10 functions as a support, or may be configured to be supported by another support (not illustrated) such as a metal member.

The solid electrolyte layer 10 has oxide ion conductivity. Specifically, the solid electrolyte layer 10 may be formed in a layer shape from a solid electrolyte having oxide ion conductivity. The solid electrolyte layer 10 is usually formed to be dense in order to ensure gas tightness. As the solid electrolyte forming the solid electrolyte layer for example, zirconium oxide based oxides such as yttria-stabilized zirconia (YSZ) and scandia-stabilized zirconia (ScSZ) may be preferably used from the viewpoints of excellent strength and thermal stability, for example. As the solid electrolyte forming the solid electrolyte layer 10, yttria-stabilized zirconia may be preferably used from the viewpoints of the oxide ion conductivity, the mechanical stability, the compatibility with other materials, and the chemical stability from an oxidizing atmosphere to a reducing atmosphere, for example.

When the solid electrolyte layer 10 is not made to function as a support, the thickness of the solid electrolyte layer 10 can be set to preferably 3 to 20 μm, more preferably 3.5 to 15 μm, and even more preferably 4 to 10 μm from the viewpoint of electrical resistance and the like. When the solid electrolyte layer 10 functions as a support, the thickness of the solid electrolyte layer 10 can be set to preferably 30 to 300 μm, more preferably 50 to 200 μm, and even more preferably 100 to 150 μm from the viewpoint of strength, electric resistance, and the like.

The electrode 3 is used as an air electrode (oxidant electrode) when the electrochemical cell 1 is used as an SOFC. In this case, an oxygen-containing gas such as air or oxygen gas is supplied to the electrode 3 as an oxidizing agent. On the other hand, when the electrochemical cell 1 is used as an SOEC, the electrode 3 is used as an oxygen electrode. In this case, a gas such as air may or may not be supplied to the electrode 3.

Specifically, as shown in FIG. 1, the electrode 3 may be disposed to face the fuel electrode 2 with the solid electrolyte layer 10 interposed therebetween. For example, an outer shape of the electrode 3 may be formed to have the same size as an outer shape of the fuel electrode 2, or may be formed to be smaller than the outer shape of the fuel electrode 2. The electrode 3 can be formed to be porous. The electrode 3 may be formed in a layer shape, and may be composed of a single layer or multiple layers. FIG. 1 shows an example in which the electrode 3 is composed of a single layer.

Examples of the electrode 33 include transmission metal perovskite-type oxides and mixtures of the transmission metal perovskite-type oxides and ceria (CeO₂) or ceria-based solid solutions. Examples of the transition metal perovskite-type oxides include lanthanum-strontium-cobalt oxide, lanthanum-strontium-cobalt-iron oxide, and lanthanum-strontium-manganese-iron oxide. The ceria-based solid solutions are obtained by doping one or more elements selected from the group consisting of Gd, Sm, Y, La, Nd, Yb, Ca, and Ho to ceria. These materials can be used alone or in combination of two or more.

The thickness of the electrode 3 may be preferably 10 μm or more, more preferably 15 μm or more, even more preferably 20 μm or more, and even more preferably 25 μm or more, from the viewpoint of securing a sufficient reaction point or the like. The thickness of the electrode 3 can be preferably 100 μm or less, more preferably 60 μm or less, and even more preferably 50 μm or less from the viewpoint of gas diffusivity, electric resistance, and the like.

In a case where the electrochemical cell 1 has an intermediate layer, the intermediate layer may specifically be configured as a layer of a solid electrolyte having oxide ion conductivity. Examples of the solid electrolyte used for the intermediate layer include ceria (CeO₂) and ceria-based solid solutions in which one or more elements selected from the group consisting of Gd, Sm, Y, La, Nd, Yb, Ca, and Ho are doped to ceria. These materials can be used alone or in combination of two or more. As the solid electrolyte used for the intermediate layer, ceria doped with Gd is preferable.

The thickness of the intermediate layer can be set to preferably 1 to 20 μm, more preferably 2 to 10 μm, from the viewpoint of reduction of ohmic resistance, restriction of element diffusion from the electrode 3, and the like.

The electrochemical cell 1 can be adopted as at least one of the SOFC and the SOEC. That is, the electrochemical cell 1 may be operated as the SOFC, may be operated as the SOEC, and may be configured to be switchable between an SOFC mode operated as the SOFC and an SOEC mode operated as the SOEC.

### Second Embodiment

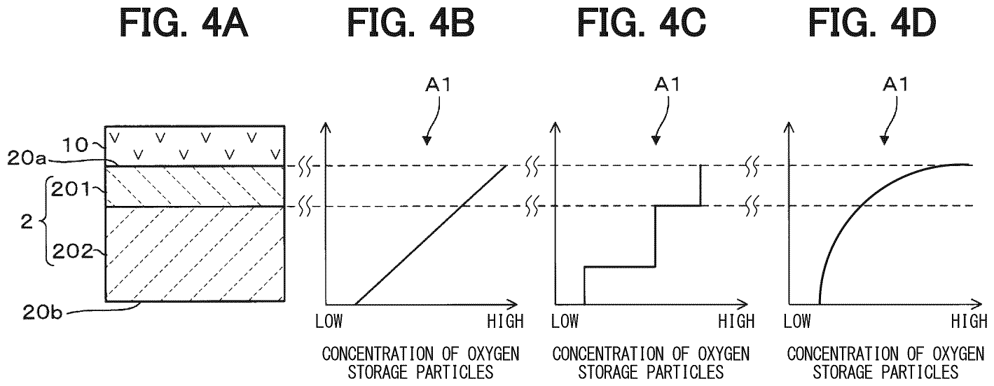

A fuel electrode and an electrochemical cell according to a second embodiment will be described with reference to FIGS. 4A to 4D. Incidentally, among reference numerals used in the second and subsequent embodiments, the same reference numerals as those used in the embodiment already described represent the same components as those in the embodiment already described, unless otherwise indicated.

As illustrated in FIGS. 4A to 4D, a fuel electrode 2 of the present embodiment has a concentration distribution A1 of oxygen storage particles 23 when viewed in a cross section along a thickness direction of the fuel electrode 2. In the fuel electrode 2 of the present embodiment, in the concentration distribution A1, a surface 20a of the fuel electrode 2 located on the solid electrolyte layer 10 has a higher concentration of the oxygen storage particles than another surface 20b of the fuel electrode 2 located opposite the solid electrolyte layer 10.

In the fuel electrode 2, a region close to the solid electrolyte layer 10, which is a region having a certain depth from the surface 20a on the solid electrolyte layer 10 toward an inner side in the thickness direction, is a region in which the power generation reaction or the water electrolysis reaction is more likely to occur than a remaining region, which is a region excluding the region close to the solid electrolyte layer 10.

Therefore, according to the above configuration, it is possible to efficiently restrict the water vapor oxidation of the metal particles 22 involved in the power generation reaction and the water electrolysis reaction in the fuel electrode 2.

In the present embodiment, for example, as illustrated in FIG. 4A, the fuel electrode 2 can be configured to include a reaction layer 201 disposed on the solid electrolyte layer 10 and a diffusion layer 202 disposed opposite the solid electrolyte layer 10. In this case, a concentration of the oxygen storage particles 23 in the reaction layer 201 can be higher than a concentration of the oxygen storage particles 23 in the diffusion layer 202. According to this configuration, it is possible to efficiently restrict the water vapor oxidation of the metal particles 22 present in the reaction layer 201 that mainly causes the power generation reaction and the water electrolysis reaction.

In the present embodiment, for example, as illustrated in FIG. 4B, the concentration distribution A1 can be set such that the concentration of the oxygen storage particles 23 increases at a constant inclination (the concentration of the oxygen storage particles 23 gradually increases) from the surface 20b located opposite the solid electrolyte layer 10 toward the surface 20a located on the solid electrolyte layer 10. In another example, as illustrated in FIG. 4C, the concentration distribution A1 can be set such that the concentration of the oxygen storage particles 23 increases stepwise from the surface 20b located opposite the solid electrolyte layer 10 toward the surface 20a located on the solid electrolyte layer 10. In another example, as illustrated in FIG. 4D, the concentration distribution A1 can be set such that the concentration of the oxygen storage particles 23 increases in a curved manner from the surface 20b located opposite the solid electrolyte layer 10 toward the surface 20a located on the solid electrolyte layer 10.

An electrochemical cell 1 of the present embodiment includes the fuel electrode 2 of the present embodiment. Therefore, in the electrochemical cell 1 of the present embodiment, deterioration of the fuel electrode 2 due to the water vapor gas can be efficiently restricted while restricting decrease in the electrode activity of the fuel electrode 2, and long-term stability can be improved.

Other configurations and effects are similar to those of the first embodiment.

### Third Embodiment

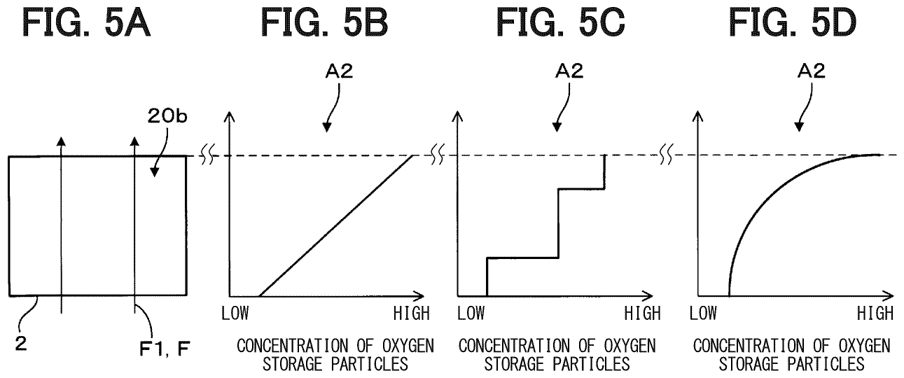

A fuel electrode and an electrochemical cell according to a third embodiment will be described with reference to FIGS. 5A to 5D. A fuel electrode 2 of the present embodiment is used in a solid oxide fuel cell as an electrochemical cell 1. The electrochemical cell 1 of the present embodiment is a solid oxide fuel cell.

As illustrated in FIGS. 5A to 5D, the fuel electrode 2 of the present embodiment has a concentration distribution A2 of the oxygen storage particles 23 when viewed on the surface 20b of the fuel electrode 2 that is located opposite the surface 20a located on the solid electrolyte layer 10, that is, an introduction surface of the fuel F. In the fuel electrode 2 of the present embodiment, in the concentration distribution A2, a concentration of the oxygen storage particles is higher in a portion of the fuel electrode 2 located downstream in a flow direction of the fuel F with respect to a central portion of the fuel electrode 2 than in a portion of the fuel electrode 2 located upstream with respect to the central portion.

In general, when the SOFC is operated, a fuel electrode side gas flow path (not illustrated) is disposed so as to be in contact with the fuel electrode 2. The hydrogen-containing gas F1 as the fuel F supplied from a supply port (not illustrated) of the fuel electrode side gas flow path flows in the fuel electrode side gas flow path along the surface 20b of the fuel electrode 2 that is located opposite the surface 20a located on the solid electrolyte layer 10. As illustrated in FIG. 5A, the flow direction of the fuel F is usually one direction from the supply port on the upstream side toward a discharge port on the downstream side. A part of the fuel F is introduced into the fuel electrode 2 from the surface 20b of the fuel electrode 2 while flowing in the fuel electrode side gas flow path. The water vapor gas generated by the power generation reaction flows through the fuel electrode side gas flow path together with the remaining fuel F that has not been introduced into the fuel electrode 2, and is discharged from the discharge port. Therefore, in the fuel electrode 2 applied to the SOFC, the water vapor gas generated by the power generation reaction increases toward the downstream side in the flow direction of the fuel F. Water vapor can be mixed with the hydrogen-containing gas F1 for humidification or the like.

Therefore, according to the above configuration, it is possible to efficiently restrict the water vapor oxidation of the metal particles 22 involved in the power generation reaction in the fuel electrode 2.

In the present embodiment, for example, as illustrated in FIG. 5B, the concentration distribution A2 can be set such that the concentration of the oxygen storage particles 23 increases at a constant inclination (the concentration of the oxygen storage particles 23 gradually increases) from an upstream side toward a downstream side in a flow direction of the fuel F (from the supply port toward the discharge port of the fuel F). In another example, as illustrated in FIG. 5C, the concentration distribution A2 can be set such that the concentration of the oxygen storage particles 23 increases stepwise from the upstream side to the downstream side in the flow direction of the fuel F (from the supply port to the discharge port of the fuel F). In another example, as illustrated in FIG. 5D, the concentration distribution A2 can be set such that the concentration of the oxygen storage particles 23 increases in a curved manner from the upstream side to the downstream side in the flow direction of the fuel F (from the supply port to the discharge port of the fuel F).

The electrochemical cell 1 of the present embodiment includes the fuel electrode 2 of the present embodiment. Therefore, in the electrochemical cell 1 of the present embodiment, deterioration of the fuel electrode 2 due to the water vapor gas can be efficiently restricted while restricting decrease in the electrode activity of the fuel electrode 2, and long-term stability can be improved.

Other configurations and effects are similar to those of the first and second embodiments.

### Fourth Embodiment

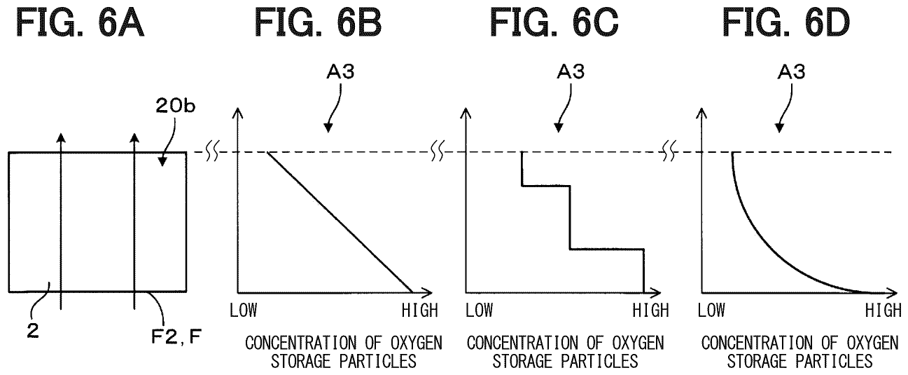

A fuel electrode and an electrochemical cell according to a fourth embodiment will be described with reference to FIGS. 6A to 6D. A fuel electrode 2 of the present embodiment is used in a solid oxide electrolysis cell as an electrochemical cell 1. The electrochemical cell 1 of the present embodiment is a solid oxide electrolysis cell, specifically, a water electrolysis cell.

As illustrated in FIGS. 6A to 6D, the fuel electrode 2 of the present embodiment has a concentration distribution A3 of the oxygen storage particles 23 when viewed on the surface 20b of the fuel electrode 2 that is located opposite the surface 20a located on the solid electrolyte layer 10, that is, the introduction surface of the fuel F. In the fuel electrode 2 of the present embodiment, in the concentration distribution A3, a concentration of the oxygen storage particles is higher in a portion of the fuel electrode 2 located upstream in a flow direction of the fuel F with respect to a central portion than in a portion of the fuel electrode 2 located downstream with respect to the central portion.

In general, when the SOEC is operated, a fuel electrode side gas flow path (not illustrated) is disposed so as to be in contact with the fuel electrode 2. The water-containing gas F2 as the fuel F supplied from the supply port (not illustrated) of the fuel electrode side gas flow path flows in the fuel electrode side gas flow path along the surface 20b of the fuel electrode 2 that is located opposite the surface 10a located on the solid electrolyte layer 10. As illustrated in FIG. 6A, the flow direction of the fuel F is usually one direction from the supply port on the upstream side toward the discharge port on the downstream side. A part of the fuel F is introduced into the fuel electrode 2 from the surface 20b of the fuel electrode 2 while flowing in the fuel electrode side gas flow path. The hydrogen gas generated by the water electrolysis reaction flows through the fuel electrode side gas flow path together with the remaining fuel F that has not been introduced into the fuel electrode 2, and is discharged from the discharge port. Therefore, in the fuel electrode 2 applied to the SOEC, the water vapor gas contained in the water-containing gas F2 as the fuel F increases toward the upstream side in the flow direction of the fuel F. A conditioning gas (reducing gas) such as hydrogen gas can be mixed with the water-containing gas F2.

Therefore, according to the above configuration, it is possible to efficiently restrict the water vapor oxidation of the metal particles 22 involved in the water electrolysis reaction in the fuel electrode 2.

In the present embodiment, for example, as illustrated in FIG. 6B, the concentration distribution A3 can be set such that the concentration of the oxygen storage particles 23 decreases at a constant inclination (the concentration of the oxygen storage particles 23 gradually decreases from the upstream side toward the downstream side in the flow direction of the fuel F (from the supply port toward the discharge port of the fuel F). In another example, as illustrated in FIG. 6C, the concentration distribution A3 can be set such that the concentration of the oxygen storage particles 23 decreases stepwise from the upstream side to the downstream side in the flow direction of the fuel F (from the supply port to the discharge port of the fuel F). In another example, as illustrated in FIG. 6D, the concentration distribution A3 can be set such that the concentration of the oxygen storage particles 23 decreases in a curved manner from the upstream side to the downstream side in the flow direction of the fuel F (from the supply port to the discharge port of the fuel F).

The electrochemical cell 1 of the present embodiment includes the fuel electrode 2 of the present embodiment. Therefore, in the electrochemical cell 1 of the present embodiment, deterioration of the fuel electrode 2 due to the water vapor gas can be efficiently restricted while restricting decrease in the electrode activity of the fuel electrode 2, and long-term stability can be improved.

Other configurations and effects are similar to those of the first and second embodiments.

### Experimental Example 1

### Material Preparation

NiO powder (average particle size: 0.5 μm), yttria-stabilized zirconia (hereinafter, YSZ) powder containing 8 mol % of Y₂O₃ (average particle size: 0.2 μm), LCZ powder (average particle size: 0.5 μm), carbon (pore former), polyvinyl butyral, isoamyl acetate, and 1-butanol were mixed and crushed with a ball mill to prepare a slurry. As the LCZ powder, specifically, La_{1.5}Ce_{0.5}Zr₂O₇ powder as La—Ce—Zr oxide powder was used. In addition, the mixing and crushing were performed for 24 hours or more in order to sufficiently disperse the respective materials. The mass ratio of the NiO powder to the YSZ powder was 65:35. The addition amount of the LCZ powder was 10 mass % with respect to the total mass of the NiO powder and the YSZ powder. Using a doctor blade method, the slurry was applied in layers on a resin sheet and dried, and then the resin sheet was peeled off to prepare a fuel electrode forming sheet. The average particle diameter is a particle diameter d₅₀ when the volume-based cumulative frequency distribution measured by the laser diffraction and scattering method shows 50% (the same applies hereinafter). In the present example, the average particle diameter of the LCZ powder is set to 0.5 μm, but the average particle diameter of the LCZ powder can be selected from a range of, for example, 0.1 to 1 μm. In the present example, the addition amount of the LCZ powder is set to 10 mass %, but the addition amount of the LCZ powder can be selected from a range of, for example, 1 to 20 mass %.

YSZ powder (average particle size: 0.2 μm), polyvinyl butyral, isoamyl acetate, and 1-butanol were mixed with a ball mill to prepare a slurry. Thereafter, a solid electrolyte layer forming sheet was prepared in a manner similar to the preparation of fuel electrode forming sheet.

Gd-doped CeO₂ (hereinafter, GDC) powder (average particle size: 0.3 μm), polyvinyl butyral, isoamyl acetate, and 1-butanol were mixed with a ball mill to prepare a slurry. In this experimental example, CeO₂ doped with 10 mol % Gd was used as the GDC. Thereafter, an intermediate layer forming sheet was prepared in a manner similar to the preparation of the fuel electrode forming sheet.

LSC (La_{0.6}Sr_{0.4}CoO₃) powder (average particle size: 2.0 μm), ethyl cellulose, and terpineol were kneaded with three rolls to prepare an electrode forming paste.

### Preparation of Electrochemical Cell

The fuel electrode forming sheet, the solid electrolyte layer forming sheet, and the intermediate layer forming sheet were laminated in this order, and pressure-bonded using a hydrostatic pressing (WIP) molding method. The WIP molding was performed under conditions of a temperature of 85° C., a pressurizing force of 50 MPa, and a pressurizing time of 10 minutes. The obtained molded body was fired at about 500° C. and degreased.

Next, the obtained molded body was fired at 1400° C. for 2 hours in an air atmosphere. As a result, a fired body in which a layered fuel electrode (thickness: 200 μm), a solid electrolyte layer (thickness: 3.5 μm), and an intermediate layer (thickness: 3 μm) were laminated in this order was obtained.

Next, the electrode forming paste was applied to the surface of the intermediate layer in the fired body by a screen printing method, and the resultant was fired (baked) at 950° C. for 2 hours in an air atmosphere to form a layered electrode (thickness: 50 μm) paired with the fuel electrode. The outer shape of the electrode was formed to be smaller than the outer shape of the fuel electrode. Accordingly, a flat cell was formed.

Next, the cell was appropriately sealed with glass to form a gas seal structure. Thereafter, the fuel electrode of this cell was subjected to a reduction treatment at 800° C. for 3 hours in a hydrogen atmosphere. As described above, the fuel electrode and the electrochemical cell of Sample 1 were obtained. The electrochemical cell produced in this example is a coin-shaped single cell.

A fuel electrode and an electrochemical cell of Sample 1C were produced in a similar manner to the production of the fuel electrode and the electrochemical cell of Sample 1 except that CeZr₃O₈ (hereinafter, CZ) powder (average particle diameter: 1.0 μm) as Ce—Zr oxide powder was used instead of the LCZ powder at the time of producing the fuel electrode forming sheet. A fuel electrode and an electrochemical cell of Sample 2C were produced in a manner similar to the production of the fuel electrode and the electrochemical cell of Sample 1 except that the LCZ powder was not added at the time of producing the fuel electrode forming sheet.

### TEM-EDX Analysis of the Cross Section of the Fuel Electrode

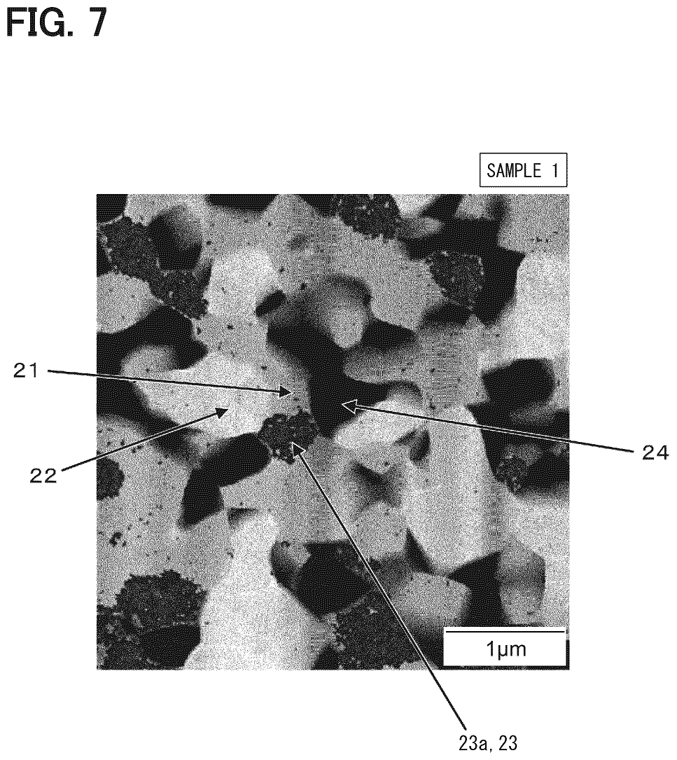

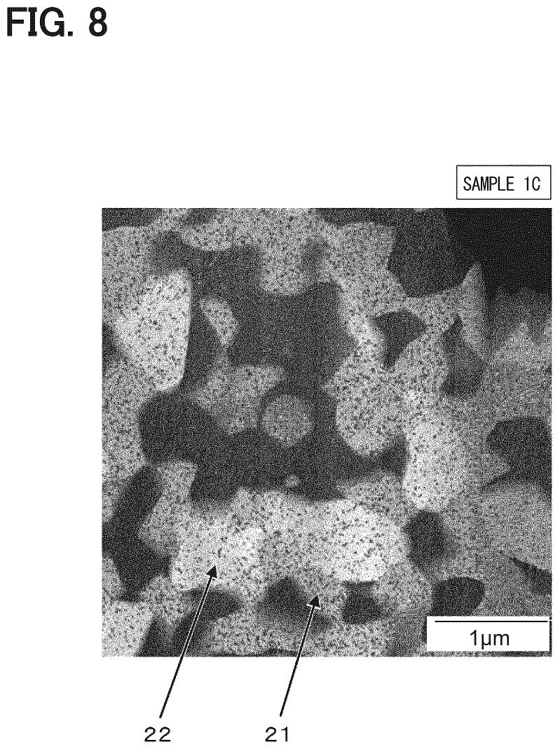

For Sample 1 and Sample 1C, TEM-EDX analysis was performed on a cross section along the thickness direction of the fuel electrode, and EDX mapping of each fuel electrode was acquired. FIG. 7 shows a La element distribution in the cross section of the fuel electrode in Sample 1. In FIG. 7, a portion denoted by reference numeral 23a is a portion where the La element is present. FIG. 8 shows a Ce element distribution in the cross section of the fuel electrode in Sample 1C. In FIG. 8, dotted portions seen in the ion conductive particles 21 (YSZ particles in this example) and the metal particles 22 (Ni particles in this example) are Ce elements.

As shown in FIG. 8, in the fuel electrode of Sample 1C, it is found that the Ce element is widely distributed in the ion conductive particles 21 and the metal particles 22. That is, most of the Ce element is dissolved in the ion conductive particles 21 and the metal particles 22. From this result, it is found that, in the fuel electrode of Sample 1C, CZ constituting the CZ powder used as the raw material is not present as particles after the high temperature firing and the reduction of the cell. On the other hand, as shown in FIG. 7, it can be seen that the La element is distributed in the form of particles in the fuel electrode of Sample 1. That is, in the fuel electrode of Sample 1, it is found that the LSZ particles as the oxygen storage particles 23 maintain the structure even after the high temperature firing and the reduction of the cell. According to FIG. 7, it can also be seen that the fuel electrode of Sample 1 has a microstructure in which the oxygen storage particles 23 are in contact with the ion conductive particles 21, the metal particles 22, and the pores 24. It is preferable that, in the microstructure, 50% or more of the oxygen storage particles 23 are in contact with all of the ion conductive particles 21, the metal particles 22, and the pores 24.

### Durability Test of Electrochemical Cell

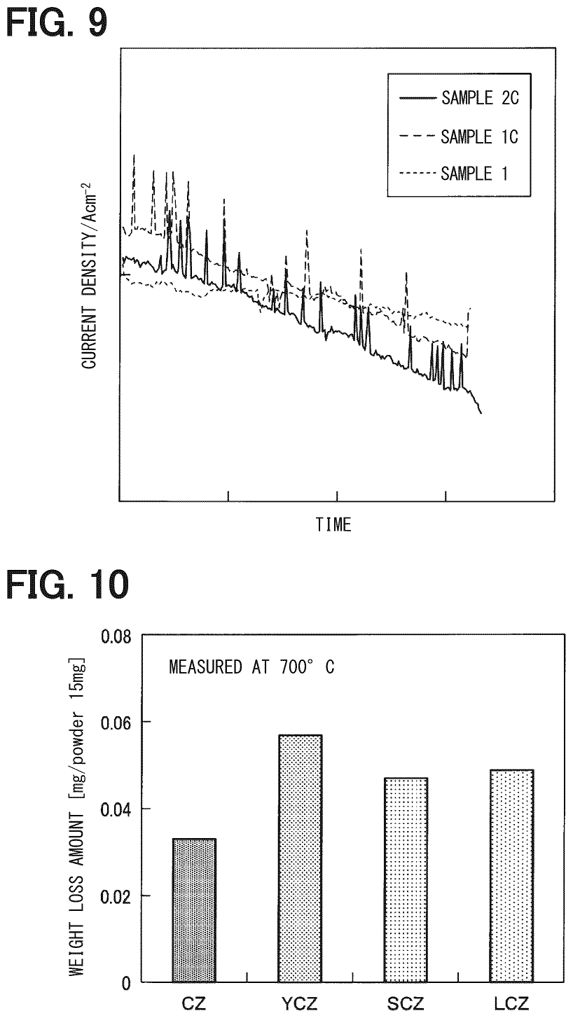

The electrochemical cells of Sample 1, Sample 1C, and Sample 2C were operated as SOECs, and the deterioration of each fuel electrode was investigated. Specifically, water electrolysis was carried out at a constant voltage of 1.3 V using each electrochemical cell 1. At this time, a mixed gas of H₂O, H₂, and N₂ (H₂O:H₂:N₂=30:30:40 in volume ratio) was supplied to the fuel electrode, and air was supplied to the electrode to be the oxygen electrode. The cell operating temperature was 700° C. The results are shown in FIG. 9. As shown in FIG. 9, the electrochemical cell of Sample 1 containing oxygen storage particles in the fuel electrode had a current deterioration rate of about ¼ as compared with the electrochemical cells of Samples 1C and 2C not containing oxygen storage particles in the fuel electrode. In the electrochemical cell of Sample 2C, the oxygen storage powder is added to the material for forming the fuel electrode, but the oxygen storage material does not remain as particles in the formed fuel electrode and is decomposed. From these results, it was confirmed that by including the oxygen storage particles in the fuel electrode, water vapor oxidation of the metal particles is restricted, deterioration of the fuel electrode due to water vapor gas can be restricted while restricting decrease in electrode activity of the fuel electrode, and an electrochemical cell excellent in long-term stability can be obtained. In the present example, the electrochemical cell is operated as the SOEC. However, according to the results of the present example, it is easily understood that similar results can be obtained even when the electrochemical cell is operated as the SOFC.

### Experimental Example 2

Oxygen storage capacities of various oxygen storage materials were measured by the thermogravimetric analysis (TGA) described above. In this example, specifically, CeZr₃O₈ (CZ) powder as Ce—Zr oxide powder, La_{1.5}Ce_{0.5}Zr₂O₇ (LCZ) powder as La—Ce—Zr oxide powder, Y_{0.13}Ce_{0.10}Zr_{0.77}O₂ (YCZ) powder as Y—Ce—Zr oxide powder, and Sc_{0.13}Ce_{0.10}Zr_{0.77}O₂ (SCZ) powder as the Sc—Ce—Zr oxide powder were used as the oxygen storage materials. As a thermogravimetric analyzer, TGA2 manufactured by Mettler Toledo was used. The results are shown in FIG. 10.

As shown in FIG. 10, it was confirmed that each of the oxygen storage materials had an oxygen storage capacity with a weight loss amount of 0.02 mg or more per 15 mg of the oxygen storage material by thermogravimetric analysis.

### Experimental Example 3

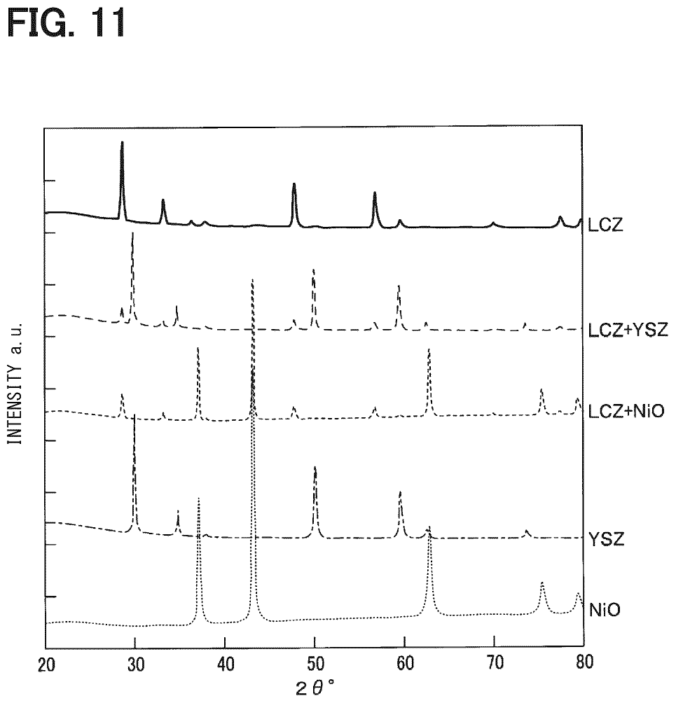

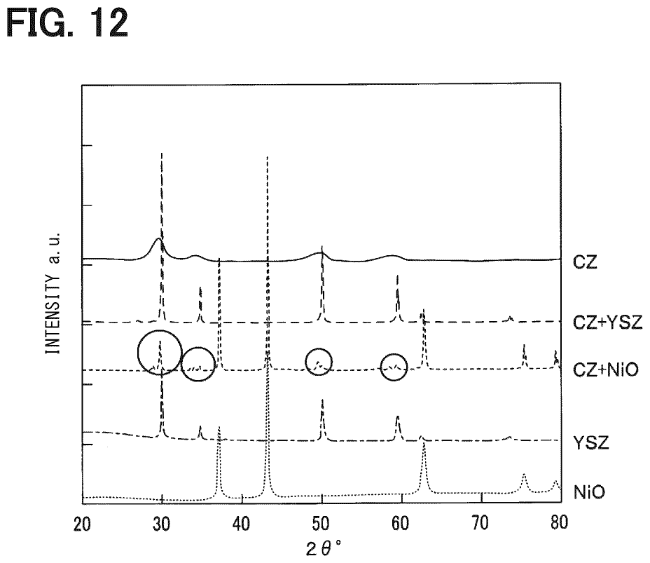

An influence of high temperature firing on YSZ, NiO, LCZ, and CZ used as raw materials for the fuel electrode in Experimental Example 1 was examined. Specifically, a mixed powder pellet obtained by mixing LCZ and NiO at a mass ratio of 10:35, a mixed powder pellet obtained by mixing LCZ and YSZ at a mass ratio of 10:65, a powder pellet formed of LCZ alone, a powder pellet formed of YSZ alone, and a powder pellet formed of NiO alone were fired at a cell firing temperature of 1400° C., and X-ray diffraction (XRD) measurement was performed using an X-ray diffraction apparatus (full automatic multipurpose X-ray diffractometer “SmartLab” manufactured by Rigaku Corporation). Similarly, a mixed powder pellet obtained by mixing CZ and NiO at a mass ratio of 10:35, a mixed powder pellet obtained by mixing CZ and YSZ at a mass ratio of 10:65, a powder pellet formed of CZ alone, a powder pellet formed of YSZ alone, and a powder pellet formed of NiO alone were fired at 1400° C., and X-ray diffraction (XRD) measurement was performed. The results are shown in FIG. 11 and FIG. 12.

As shown in FIG. 11, in each of the sample in which LCZ and NiO were co-fired and the sample in which LCZ and YSZ were co-fired, the peak of LCZ was maintained without separation. From this result, it can be seen that the LCZ can maintain the structure as particles in the fuel electrode. On the other hand, as shown in FIG. 12, in the sample in which CZ and NiO were co-fired, the peak of CZ was separated into two (in FIG. 12, circled portions), and CZ was separated into two phases. This result shows that it is difficult for CZ to maintain its structure as particles in the fuel electrode.

The present disclosure is not limited to each of the above-described embodiments and experimental examples, and various modifications can be made without departing from the gist of the present disclosure. In addition, each configuration shown in each embodiment and each experimental example can be optionally combined. That is, although the present disclosure has been described in accordance with the embodiments, it is understood that the present disclosure is not limited to the embodiments, structures, and the like. The present disclosure encompasses various modifications and variations within the scope of equivalents. In addition, various combinations and configurations, as well as other combinations and configurations that include only one element, more, or less, fall within the scope and spirit of the present disclosure.

What is claimed is:

1. A fuel electrode configured to be adopted to an electrochemical cell that includes a solid electrolyte layer having oxide ion conductivity, and to be supplied with a fuel, the fuel electrode comprising:
ion conductive particles having oxide ion conductivity;
metal particles;
oxygen storage particles having oxygen storage capacity; and
pores, wherein
the electrochemical cell is a solid oxide fuel cell, and
when viewed on a surface of the fuel electrode located opposite another surface of the fuel electrode to be disposed on the solid electrolyte layer, the fuel electrode has a concentration distribution in which a concentration of the oxygen storage particles is higher in a portion of the fuel electrode located downstream in a flow direction of the fuel with respect to a central portion of the fuel electrode than in a portion of the fuel electrode located upstream with respect to the central portion.

2. The fuel electrode according to claim 1, wherein
the fuel electrode has a microstructure in which the oxygen storage particles are in contact with the ion conductive particles, the metal particles, and the pores.

3. The fuel electrode according to claim 1, wherein
the oxygen storage particles have a pyrochlore structure or a fluorite structure.

4. The fuel electrode according to claim 1, wherein
the oxygen storage particles are made of an oxygen storage material that is an oxide containing Zr and at least one element selected from a group consisting of Al, Ce, La, Pr, Nd, Y, and Sc.

5. The fuel electrode according to claim 1, wherein
when viewed in a cross section along a thickness direction of the fuel electrode, the fuel electrode further has a concentration distribution in which a surface of the fuel electrode to be disposed on the solid electrolyte layer has a higher concentration of the oxygen storage particles than another surface of the fuel electrode to be disposed opposite the solid electrolyte layer.

6. The fuel electrode according to claim 1, wherein
the metal particles are at least one selected from a group consisting of Ni particles, Cu particles, and Co particles.

7. An electrochemical cell comprising:
a solid electrolyte layer having oxide ion conductivity;
a fuel electrode configured to be supplied with a fuel and including ion conductive particles having oxide ion conductivity, metal particles, oxygen storage particles having oxygen storage capacity, and pores; and
an electrode disposed on another surface of the solid electrolyte layer and paired with the fuel electrode, wherein
the electrochemical cell is a solid oxide fuel cell, and
when viewed on a surface of the fuel electrode located opposite another surface of the fuel electrode to be disposed on the solid electrolyte layer, the fuel electrode has a concentration distribution in which a concentration of the oxygen storage particles is higher in a portion of the fuel electrode located downstream in a flow direction of the fuel with respect to a central portion of the fuel electrode than in a portion of the fuel electrode located upstream with respect to the central portion.

8. A fuel electrode configured to be adopted to an electrochemical cell that includes a solid electrolyte layer having oxide ion conductivity, and to be supplied with a fuel, the fuel electrode comprising:
ion conductive particles having oxide ion conductivity;
metal particles;
oxygen storage particles having oxygen storage capacity; and
pores, wherein
the electrochemical cell is a solid oxide electrolysis cell,
when viewed on a surface of the fuel electrode located opposite another surface of the fuel electrode to be disposed on the solid electrolyte layer, the fuel electrode has a concentration distribution in which a concentration of the oxygen storage particles is higher in a portion of the fuel electrode located upstream in a flow direction of the fuel with respect to a central portion of the fuel electrode than in a portion of the fuel electrode located downstream with respect to the central portion.

9. The fuel electrode according to claim 8, wherein
the fuel electrode has a microstructure in which the oxygen storage particles are in contact with the ion conductive particles, the metal particles, and the pores.

10. The fuel electrode according to claim 8, wherein
the oxygen storage particles have a pyrochlore structure or a fluorite structure.

11. The fuel electrode according to claim 8, wherein
the oxygen storage particles are made of an oxygen storage material that is an oxide containing Zr and at least one element selected from a group consisting of Al, Ce, La, Pr, Nd, Y, and Sc.

12. The fuel electrode according to claim 8, wherein
when viewed in a cross section along a thickness direction of the fuel electrode, the fuel electrode further has a concentration distribution in which a surface of the fuel electrode to be disposed on the solid electrolyte layer has a higher concentration of the oxygen storage particles than another surface of the fuel electrode to be disposed opposite the solid electrolyte layer.

13. The fuel electrode according to claim 8, wherein
the metal particles are at least one selected from a group consisting of Ni particles, Cu particles, and Co particles.

14. An electrochemical cell comprising:
a solid electrolyte layer having oxide ion conductivity;
a fuel electrode configured to be supplied with a fuel and including ion conductive particles having oxide ion conductivity, metal particles, oxygen storage particles having oxygen storage capacity, and pores; and
an electrode disposed on another surface of the solid electrolyte layer and paired with the fuel electrode, wherein
the electrochemical cell is a solid oxide electrolysis cell,
when viewed on a surface of the fuel electrode located opposite another surface of the fuel electrode to be disposed on the solid electrolyte layer, the fuel electrode has a concentration distribution in which a concentration of the oxygen storage particles is higher in a portion of the fuel electrode located upstream in a flow direction of the fuel with respect to a central portion of the fuel electrode than in a portion of the fuel electrode located downstream with respect to the central portion.
